(19) United States
(12) Patent Application Publication
(10) Pub. No.: US 2025/0122981 A1
(43) Pub. Date: Apr. 17, 2025

(54) METHOD FOR STORING AND TRANSPORTING HYDRATE WITH HIGH NATURAL GAS STORAGE CAPACITY

(71) Applicant: GUANGZHOU INSTITUTE OF ENERGY CONVERSION, CHINESE ACADEMY OF SCIENCES, Guangzhou (CN)

(72) Inventors: Xiaosen LI, Guangzhou (CN); Yisong YU, Guangzhou (CN); Jianwu LIU, Guangzhou (CN); Wenzhe SUN, Guangzhou (CN); Zhaoyang CHEN, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 18/645,427

(22) Filed: Apr. 25, 2024

Related U.S. Application Data
(63) Continuation of application No. PCT/CN2023/131396, filed on Nov. 14, 2023.

(30) Foreign Application Priority Data
Oct. 13, 2023 (CN) 202311323754.6

(51) Int. Cl. F17C 11/00; C10L 3/10

(52) U.S. Cl. CPC F17C 11/007; C10L 3/108; F17C 2221/033; F17C 2221/036

(57) ABSTRACT

A method for storing and transporting a hydrate with high natural gas storage capacity is provided. The method adopts a mode of generating the hydrate at a low temperature and storing the hydrate at a high temperature, and specifically includes: in a mode that a hydrate reaction tank is used as a transportation tank at the same time, introducing a mixed hydrate reaction liquid into the hydrate reaction tank matched with a transportation vehicle; introducing natural gas; enabling a hydrate generation reaction at a temperature of 273.65-283.15 K; in case of equilibrium of the reaction, heating to a temperature of less than or equal to 298.15 K for storage for long-distance transportation. By adopting the present method, the hydrate with high natural gas storage capacity can be synthesized within a relatively short period of time, and the hydrate can be safely, economically and efficiently transported to a destination.

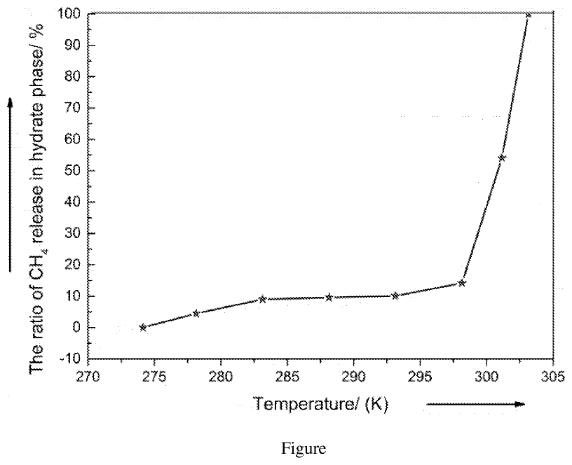

### CROSS REFERENCE TO THE RELATED APPLICATIONS

This application is a continuation application of International Application No. PCT/CN2023/131396, filed on Nov. 14, 2023, which is based upon and claims priority to Chinese Patent Application No. 202311323754.6, filed on Oct. 13, 2023, the entire contents of which are incorporated herein by reference.

### TECHNICAL FIELD

The present invention belongs to the technical field of gas storage and transportation, and particularly relates to a method for safely, economically and efficiently transporting a hydrate with high natural gas storage capacity to a destination.

### BACKGROUND

Coal, oil and natural gas, three traditional major fossil energy sources, play an important role in supporting the development of modem agriculture and industry. However, environmental contamination caused by use of the first two energy sources has also aroused widespread concern of researchers.

As a clean and environment-friendly high-quality energy, natural gas plays a more and more important role as a “protagonist of energy” in today's promotion of energy conservation and emission reduction, and its proportion in China's energy structure is also increasing. The increasing demand for natural gas is in urgent need of a method for economically and safely transporting natural gas from a gas source to users.

At present, there exist mainly three methods for commercially storing and transporting natural gas, namely pipeline transportation, liquefied natural gas (LNG) storage and transportation and compressed natural gas (CNG) storage and transportation, in which pipeline transportation is currently the mainstream method for storing and transporting. As for pipeline transportation, natural gas can be transported to consumers by laying pipelines and building fixed special stations, and gas can also be stored in pipelines; and pipeline transportation has the advantages of large traffic volume and good sustainability, but also has the inevitable problems of strong specificity, high fixed investment and poor flexibility. LNG storage and transportation is to convert natural gas from a gaseous state to a liquid state, and then transport it by ship, highway, railway and pipeline. However, before transportation, a lot of energy is required for liquefying natural gas for storage in low-temperature storage tanks. CNG storage and transportation takes advantage of the compressibility of natural gas to store gas under high pressure, with the storage pressure generally ranging from 15 MPa to 25 MP. This method demands strict requirements on storage devices and consumes a lot of energy during compression.

The gas hydrate solidified storage and transportation technology is a new natural gas transportation technology developed in recent years, which is mainly used for storage and transportation by enabling a reaction between natural gas and water at a low temperature and a high pressure to form a solid hydrate. The patent “TRANSPORT VEHICLE FOR TRANSPORTING COMBUSTIBLE ICE” (CN103754152A) puts forward a design concept of a transport vehicle for a natural gas hydrate, in which a storage cavity is cooled by installing a generator and a semiconductor refrigerator on the transport vehicle, and then heat insulating materials are installed around a carriage to maintain the low-temperature storage condition of the hydrate and to prevent the hydrate from decomposition, thus achieving the purpose of long-distance transportation. The patent “TRANSPORT VEHICLE FOR TRANSPORTING NATURAL GAS HYDRATE” (CN102371934A) also uses this principle for the purpose of hydrate transportation. The patent “HYDRATE STORAGE AND TRANSPORTATION DEVICE” (CN101520130A) proposes a tube-type layered hydrate transportation device, in which a low temperature in an internal space is mainly maintained by external refrigeration. All the above solutions adopt low-temperature and normal-pressure transportation to transport a natural gas hydrate. As mentioned above, the hydrate is a clathrate complex generated by gas and water at a low temperature and a high pressure (the gas itself provides pressure in a reactor or tank); and as the hydrate is generated, the gas is consumed and the pressure is reduced. Limited by phase equilibrium conditions of the hydrate, the low-temperature and normal-pressure storage of the hydrate means that after the gas hydrate is generated at a low temperature and a high pressure, the hydrate and unreacted gas are cooled to −30° C. or below, and then the gas is released to return to the normal pressure (with a direct loss of pressure energy), so as to ensure the stability of the hydrate. Once this is done, granulation and filling are required, and it takes a lot of energy to maintain such a low temperature during transportation to the destination. It is thus clear that although these technical solutions above can realize stable storage and transportation of the natural gas hydrate, the way of low-temperature storage needs to consume a large amount of cold energy, which will undoubtedly greatly reduce the economical efficiency of transportation of the hydrate. Therefore, it is urgent for us to develop a method for safely, economically and efficiently transporting a hydrate with high natural gas storage capacity to a destination and store it.

### SUMMARY

An objective of the present invention is to provide a method for safely, economically and efficiently transporting a hydrate with high natural gas storage capacity based on the prior art, aiming at overcoming the shortcomings in the natural gas solidified storage and transportation technology that a gas hydrate is prone to decomposition and low-temperature storage and transportation is poor in economical efficiency.

In order to achieve the above objective, the present invention adopts the following technical solutions.

A method for storing and transporting a hydrate with high natural gas storage capacity adopts a mode of generating the hydrate at a low temperature and storing the hydrate at a high temperature, and specifically includes: in a mode that a hydrate reaction tank is used as a transportation tank at the same time, introducing a mixed hydrate reaction liquid into the hydrate reaction tank matched with a transportation vehicle; introducing natural gas; enabling a hydrate generation reaction at a temperature of 273.65-283.15 K; in case of equilibrium of the reaction, heating to a temperature of less than or equal to 298.15 K; and carrying out storage for long-distance transportation.

Preferably, the hydrate generation reaction is enabled at 274.15-283.15 K.

Preferably, the mixed hydrate reaction liquid is composed of a hydrate generation accelerator and water.

The hydrate generation accelerator includes but is not limited to cyclopentane, and other additives capable of promoting generation of the hydrate may also be used, such as tetrahydrofuran, methylcyclopentane and methylcyclohexane.

Preferably, the mixed hydrate reaction liquid is composed of cyclopentane and water. Preferably, a molar fraction of cyclopentane in the mixed hydrate reaction liquid is 5.6 mol % based on a total mole of the mixed hydrate reaction liquid.

The hydrate reaction tank may be matched with the transportation vehicle conveniently, and may be directly used as the hydrate transportation tank at the same time, thus playing a multi-purpose role.

The present invention adopts the technical solution of “low-temperature generation and high-temperature storage of hydrate” to achieve the purposes of synthesizing the hydrate with high natural gas storage capacity within a short period of time and transporting the hydrate to a destination safely, economically and efficiently. According to research of the present invention, it is found that by controlling the hydrate generation temperature within a certain low-temperature range, the hydrate with high gas stripping capacity can be generated quickly, and by continuing to raise the temperature to be close to a room temperature, the hydrate can maintain favorable stability under the pressure of unreacted gas. Therefore, the solution of the present invention meets the industrial production requirements of “fast hydrate generation, high gas stripping capacity and high transportation temperature”, and is the most economical and effective way. Specifically, according to the present invention, the temperature in the process of generating the natural gas hydrate is controlled within the range of 273.65-283.15 K, preferably within the range of 274.15-283.15 K. the hydrate with high natural gas storage capacity is obtained within 1.0-4.0 hours, and the natural gas storage capacity of the hydrate is 100-160 V/V.

The hydrate with high natural gas storage capacity is stored and transported at an approximately normal temperature after being generated. The transportation vehicle does not need to provide a refrigerating device during transportation for cooling a hydrate storage cavity to prevent the hydrate from decomposition. The ambient temperature during transportation is required to be below 298.15 K. In fact, China and a considerable number of other countries and regions in the world are subjected to this temperature condition for a relatively long period of the year.

The hydrate with high natural gas storage capacity, after being transported to the destination, is decomposed by introducing industrial waste heat, thereby releasing natural gas for use, and the hydrate reaction liquid is recycled and reused.

The present invention has the following beneficial effects.

In a cyclopentane-containing system, the natural gas hydrate is generated at 273.65-283.15 K. achieving an extremely high gas hydrate generation rate and high gas storage capacity, and time required for completing the reaction ranges from 1.0 hour to 4.0 hours. Therefore, the production efficiency is high.

The technical solution of “low-temperature generation and high-temperature storage” of the hydrate avoids investment and operating cost of a refrigerating device during transportation of the hydrate, thereby greatly reducing the transportation cost of the hydrate.

The technical solution of “low-temperature generation and high-temperature storage” of the hydrate makes it possible for the hydrate generation tank and the hydrate transportation tank to be used as the same tank, so that the technological process of the natural gas hydrate solidified storage and transportation technology can be greatly reduced, which greatly reduces the investment and operating cost of related devices and improving the economical efficiency of the industry chain.

The gas hydrate, after being transported to the destination, is decomposed by introducing industrial waste heat so as to release natural gas, which can not only make full use of the low-grade heat source, but also greatly shorten the unloading time of natural gas and improve the operating efficiency of the hydrate industry chain.

### BRIEF DESCRIPTION OF THE DRAWINGS

FIGURE shows a curve of the release ratio of natural gas in a storage and transportation tank as a function of temperature.

### DETAILED DESCRIPTION OF THE EMBODIMENTS

The main component of natural gas is methane. Therefore, a test gas selected for a laboratory was methane with a purity of 99.0 mol %. Based on a total mole of a mixed hydrate reaction liquid (water+cyclopentane), the molar fraction of cyclopentane used was 5.6 mol %. The generation of a hydrate was controlled at a preferred temperature between 274.15-283.15 K, and the transportation temperature of the hydrate was controlled to be 298.15 K or below.

As can be seen from the FIGURE, the release rate of methane from the hydrate in a storage and transportation tank did not increase significantly when the storage temperature of the hydrate was lower than 298.15 K, whereas the release ratio of methane from the hydrate in the storage and transportation tank increased significantly with a further increase of temperature. This means that the storage temperature of the hydrate with high methane storage capacity should not be higher than 298.15 K. Meanwhile, as can be seen from the following embodiments, the gas storage capacity of the directly generated hydrate was 23.7 V/V at a temperature of 293.15 K and an initial pressure of 8.0 MPa, whereas the gas storage capacity of the generated hydrate was 148.0 V/V at a temperature of 274.15 K and an initial pressure of 8.0 MPa. After heating the hydrate to 293.15 K for storage and releasing some methane gas, the methane storage capacity of the hydrate was still up to 134.09 V/V. This means that storing and transporting the hydrate with high gas storage capacity at an approximately normal temperature but not higher than 298.15 K may not cause instability of the hydrate, which can greatly reduce the investment and operating cost in providing cold energy to maintain the stability of the hydrate during transportation of the hydrate with high methane storage capacity. At such a high temperature. both of the efficiency in directly synthesizing the hydrate and the gas storage capacity of the synthesized hydrate are extremely low. It is worth noting that no hydrate was generated for up to 539 min at 293.15 K. This shows that “low-temperature generation and high-temperature storage” of the natural gas hydrate is an effective and reasonable method for industrial application of the natural gas hydrate solidified storage and transportation technology.

The implementing solutions of the present invention will be further described below with reference to the embodiments.

### Embodiment 1

Based on a total volume of 30 mL of a solution, a reaction liquid (water+cyclopentane) with a molar fraction of 5.6 mol % of cyclopentane was put into a hydrate reactor of 120 mL, then methane gas was introduced to reach a set pressure of 8 MPa, and a hydrate generation reaction was enabled at 274.15 K. Time for the reaction to reach equilibrium (i.e., time for completing the hydrate generation reaction) was 120 min, and the gas storage capacity of the obtained hydrate was 148.0 VN. When the system was stored at 293.15 K for long-distance transportation, it was found that after 48 hours of storage, the gas storage capacity of the hydrate was only reduced from 148.0 V/V to 134.09 V/V, with a reduction ratio of merely 9.4%.

### Embodiment 2

Based on a total volume of 30 mL of a solution, a reaction liquid (water+cyclopentane) with a molar fraction of 5.6 mol % of cyclopentane was put into a hydrate reactor of 120 mL, then methane gas was introduced to reach a set pressure of 8 MPa, and a hydrate generation reaction was enabled at 293.15 K. Time for the reaction to reach equilibrium (i.e., time for completing the hydrate generation reaction) was 530 min, and the gas storage capacity of the obtained hydrate was 23.7 VN. When the system was stored at 298.15 K for long-distance transportation, it was found that after 48 hours of storage, the gas storage capacity of the hydrate was only reduced from 23.7 V/V to 22.6 V/V, with a reduction ratio of merely 4.6%.

### Embodiment 3

Based on a total volume of 30 mL of a solution, a reaction liquid (water+cyclopentane) with a molar fraction of 5.6 mol % of cyclopentane was put into a hydrate reactor of 120 mL, then methane gas was introduced to reach a set pressure of 8 MPa, and a hydrate generation reaction was enabled at 283.15 K. Time for the reaction to reach equilibrium (i.e., time for completing the hydrate generation reaction) was 230 min, and the gas storage capacity of the obtained hydrate was 142.3 VN. When the system was stored at 293.15 K for long-distance transportation, it was found that after 48 hours of storage, the gas storage capacity of the hydrate was only reduced from 142.3 V/V to 134.76 V/V, with a reduction ratio of merely 5.3%.

### Embodiment 4

Based on a total volume of 30 mL of a solution, a reaction liquid (water+cyclopentane) with a molar fraction of 5.6 mol % of cyclopentane was put into a hydrate reactor of 120 mL, then methane gas was introduced to reach a set pressure of 7 MPa, and a hydrate generation reaction was enabled at 280.15 K. Time for the reaction to reach equilibrium (i.e., time for completing the hydrate generation reaction) was 187 min, and the gas storage capacity of the obtained hydrate was 137.6 VN. When the system was stored at 293.15 K for long-distance transportation, it was found that after 48 hours of storage, the gas storage capacity of the hydrate was only reduced from 137.6 V/V to 135.2 V/V, with a reduction ratio of merely 1.7%.

### Embodiment 5

Based on a total volume of 30 mL, a reaction liquid (water+cyclopentane) with a molar fraction of 5.6 mol % of cyclopentane was put into a hydrate reactor of 120 mL, then methane gas was introduced to reach a set pressure of 7 MPa, and a hydrate generation reaction was enabled at 278.15 K. Time for the reaction to reach equilibrium (i.e., time for completing the hydrate generation reaction) was 148 min, and the gas storage capacity of the obtained hydrate was 144.7 VN. When the system was stored at 288.15 K for long-distance transportation, it was found that after 48 hours of storage, the gas storage capacity of the hydrate was only reduced from 144.7 V/V to 138.5 V/V, with a reduction ratio of merely 4.3%.

### Embodiment 6

Based on a total volume of 30 mL of a solution, a reaction liquid (water+cyclopentane) with a molar fraction of 5.6 mol % of cyclopentane was put into a hydrate reactor of 120 mL, then methane gas was introduced to reach a set pressure of 7 MPa, and a hydrate generation reaction was enabled at 276.15 K. Time for the reaction to reach equilibrium (i.e., time for completing the hydrate generation reaction) was 127 min, and the gas storage capacity of the obtained hydrate was 142.3 VN. When the system was stored at 283.15 K for long-distance transportation, it was found that after 48 hours of storage, the gas storage capacity of the hydrate was only reduced from 142.3 V/V to 127.22 V/V, with a reduction ratio of merely 10.6%.

The above descriptions are only the specific embodiments of the present invention. It should be noted that the above preferred embodiments should not be regarded as limitations to the present invention. The scope of protection of the present invention shall be subject to the scope defined by the claims. Those of ordinary skill in the art can make some improvements and modifications without departing from the spirit and scope of the present invention, and these improvements and modifications shall be included into the protection scope of the present invention.

1. A method for storing and transporting a hydrate with a high natural gas storage capacity, wherein the method adopts a mode of generating the hydrate at a low temperature and storing the hydrate at a high temperature, and specifically comprises: in a mode of using a hydrate reaction tank as a transportation tank simultaneously, introducing a mixed hydrate reaction liquid into the hydrate reaction tank matched with a transportation vehicle; introducing natural gas to obtain a mixture; enabling the mixture to undergo a hydrate generation reaction at a temperature of 273.65-283.15 K to obtain the hydrate; in case of an equilibrium of the hydrate generation reaction, heating the hydrate to a temperature of less than or equal to 298.15 K for a storage for a long-distance transportation.

2. The method for storing and transporting the hydrate with the high natural gas storage capacity according to claim 1, wherein the hydrate generation reaction is conducted at 274.15-283.15 K.

3. The method for storing and transporting the hydrate with the high natural gas storage capacity according to claim 1, wherein the mixed hydrate reaction liquid comprises a hydrate generation accelerator and water.

4. The method for storing and transporting the hydrate with the high natural gas storage capacity according to claim 3, wherein the hydrate generation accelerator is cyclopentane.

5. The method for storing and transporting the hydrate with the high natural gas storage capacity according to claim 4, wherein a molar fraction of the cyclopentane is 5.6 mol % based on a total mole of the mixed hydrate reaction liquid.
